(19) United States
(12) Patent Application Publication
(10) Pub. No.: US 2009/0167729 A1
(43) Pub. Date: Jul. 2, 2009

(54) INFORMATION PROCESSING APPARATUS AND PANEL CONTROL METHOD

(75) Inventors: Yuichiro Hino, Ome-shi (JP); Katsuhiro Uchida, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/253,795

(22) Filed: Oct. 17, 2008

(30) Foreign Application Priority Data
Dec. 27, 2007 (JP) 2007-338246

(51) Int. Cl. G09G 5/00

(52) U.S. Cl. 345/204

(57) ABSTRACT

According to one embodiment, an information processing apparatus includes a display unit pivotally installed on a housing and including a magnet unit, a magnetic sensor unit incorporated in the housing to detect a movement of the magnet unit, a conversion unit which converts a magnetic force detected by the magnetic sensor unit into a pulse signal having a pulse width, a detection unit which detects an angle made by the display unit and the housing based on the pulse signal converted by the conversion unit and having the pulse width, a storage unit which stores table information storing an operation corresponding to a predetermined angle, and an operation unit which performs the predetermined operation based on the table information when the detected angle has increased to the predetermined angle, and performs the predetermined operation based on the table information when the detected angle has decreased to the predetermined angle.

### CROSS-REFERENCE TO RELATED APPLICATIONS

This application is based upon and claims the benefit of priority from Japanese Patent Application No. 2007-338246, filed Dec. 27, 2007, the entire contents of which are incorporated herein by reference.

### BACKGROUND

1. Field

One embodiment of the present invention relates to a panel open/close control technique and, more particularly, to an information processing apparatus and a panel control method which allow control using a hysteresis.

2. Description of the Related Art

A notebook personal computer or the like can generally turn on or off the LCD as the display panel opens or closes. For example, Jpn. Pat. Appln. KOKAI Publication No. 2006-220556 discloses a technique of causing a magnetic sensor incorporated in the housing to sense a magnet incorporated in the display unit and detecting the open/close angle based on a change in the magnetic field components.

In the technique disclosed in Jpn. Pat. Appln. KOKAI Publication No. 2006-220556, however, the LCD turned on/off when the opening or closing display unit has reached a predetermined angle. It is therefore impossible to set ON or OFF of the LCD at a desired angle.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view schematically showing an example of the arrangement of an information processing apparatus according to an embodiment of the present invention;

FIG. 2 is an exemplary block diagram showing the arrangement of the information processing apparatus according to the embodiment;

FIG. 3 is an exemplary block diagram showing the power supply circuit and the like of the information processing apparatus according to the embodiment;

FIG. 4 is an exemplary flowchart for explaining the panel control method of the information processing apparatus according to the embodiment;

FIG. 5 is an exemplary timing chart for explaining the panel control method of the information processing apparatus according to the embodiment;

FIG. 6 is an exemplary conceptual view showing the relationship between the open/close angle and a waveform after conversion to a voltage used by the information processing apparatus according to the embodiment; and

FIG. 7 is an exemplary conceptual view showing the relationship between the open/close speed and the open/close angle used by the information processing apparatus according to the embodiment.

### DETAILED DESCRIPTION

Various embodiments according to the invention will be described hereinafter with reference to the accompanying drawings. In general, according to one embodiment of the invention, an information processing apparatus includes: a housing; a display unit pivotally installed on the housing and including a magnet unit; a magnetic sensor unit incorporated in the housing to detect a movement of the magnet unit; a conversion unit which converts a magnetic force detected by the magnetic sensor unit into a pulse signal having a pulse width; a detection unit which detects an angle made by the display unit and the housing based on the pulse signal converted by the conversion unit and having the pulse width; a storage unit which stores table information storing an operation corresponding to a predetermined angle; and an operation unit which performs the predetermined operation based on the table information when the detected angle has increased to the predetermined angle, and performs the predetermined operation based on the table information when the detected angle has decreased to the predetermined angle.

An embodiment of the present invention will now be described with reference to the accompanying drawing.

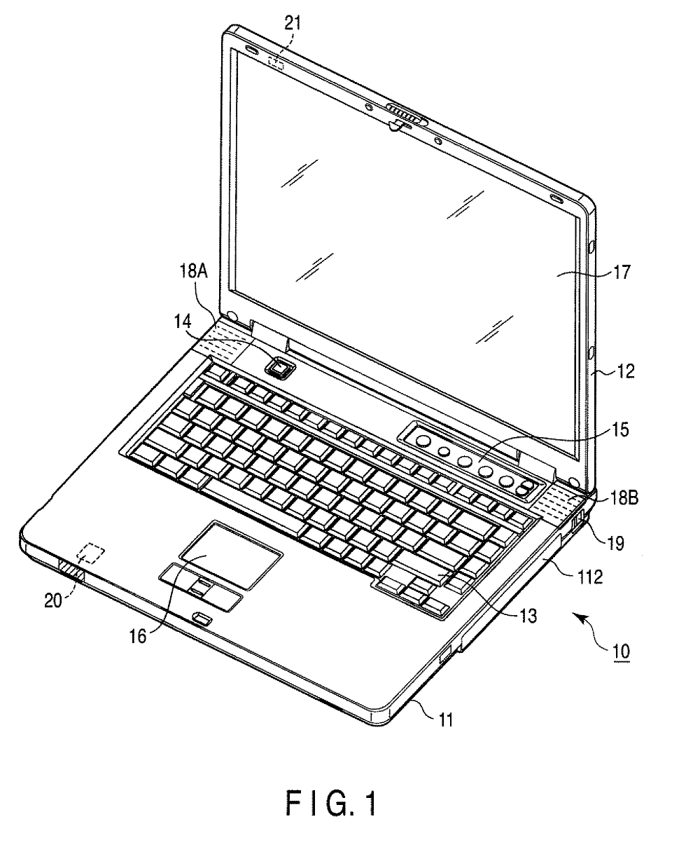

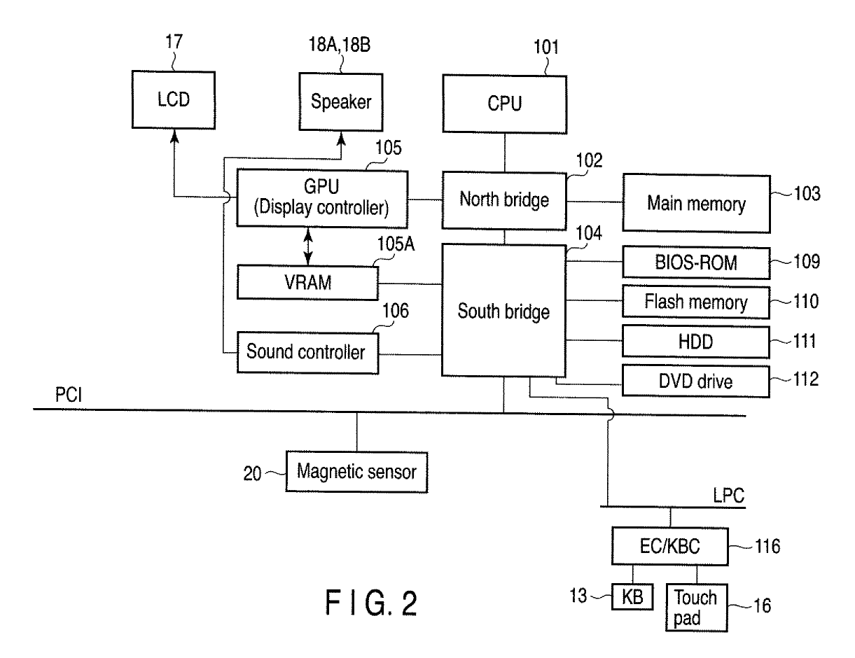

First, the arrangement of an information processing apparatus according to an embodiment of the present invention will be explained with reference to FIGS. 1 and 2. The information processing apparatus is implemented as, e.g., a notebook personal computer 10.

FIG. 1 is a perspective view showing a state in which the display unit of the notebook personal computer 10 is open. The computer 10 includes a computer main body 11 and a display unit 12. The display unit 12 has a built-in display device formed from a thin-film-transistor liquid crystal display (TFT-LCD) 17. The display screen of the LCD 17 is located almost at the center of the display unit 12. A magnet 21 is incorporated in, e.g., the upper portion of the display unit 12.

The display unit 12 is attached to the computer main body 11 to freely pivot between the open position and the close position. The computer main body 11 has a thin box-shaped housing and includes, on its upper surface, a keyboard 13, a power button 14 to power on/off the computer 10, an input operation panel 15, a touch pad 16, speakers 18A and 18B, a magnetic sensor 20, and DVD drive 112.

The input operation panel 15 is an input device that inputs an event corresponding to a pressed button. The input operation panel 15 has a plurality of buttons to activate a plurality of functions.

The system configuration of the computer 10 will be described next with reference to FIG. 2.

As shown in FIG. 2, the computer 10 includes a CPU 101, north bridge 102, main memory 103, south bridge 104, GPU 105, BIOS-RON 109, hard disk drive (HDD) 111, embedded controller/keyboard controller IC (EC/KBC) 116, speakers 18A and 18B, and magnetic sensor 20.

The CPU 101 is a processor for controlling the operation of the computer 10 and executes an operating system and a control application to control audio playback from the computer 10, which are loaded from the hard disk drive (HOD) 111 to the main memory 103. The CPU 101 also executes a Basic Input/Output System (BIOS) stored in the BIOS-ROM 109. The BIOS is a program for hardware control.

The north bridge 102 is a bridge device for connecting the local bus of the CPU 101 to the south bridge 104. The north bridge 102 incorporates a memory controller to control access to the main memory 103. The north bridge 102 also has a function of executing communication with the GPU 105 via a serial bus of PCI Express standard.

The GPU 105 is a display controller that controls the LCD 17 serving as the display monitor of the computer 10. A display signal generated by the GPU 105 is sent to the LCD 17.

The south bridge 104 controls devices on a Low Pin Count (LPC) bus and devices on a Peripheral Component Interconnect (PCI) bus. The south bridge 104 incorporates an Integrated Drive Electronics (IDE) controller to control the HDD 111.

The embedded controller/keyboard controller IC (EC/KBC) 116 is a one-chip microcomputer in which an embedded controller for power management and a keyboard controller to control the keyboard (KB) 13 and the touch pad 16 are integrated. The embedded controller/keyboard controller IC (EC/KBC) 116 has a function of powering on/off the computer 10 as the user operates the power button 14.

The magnetic sensor 20 detects the magnetic field of the magnet 21 incorporated in the display unit 12. A pulse conversion circuit converts the detected magnetic field into pulses so that the open/close angle of the display unit 12 with respect to the computer main body 11 is obtained.

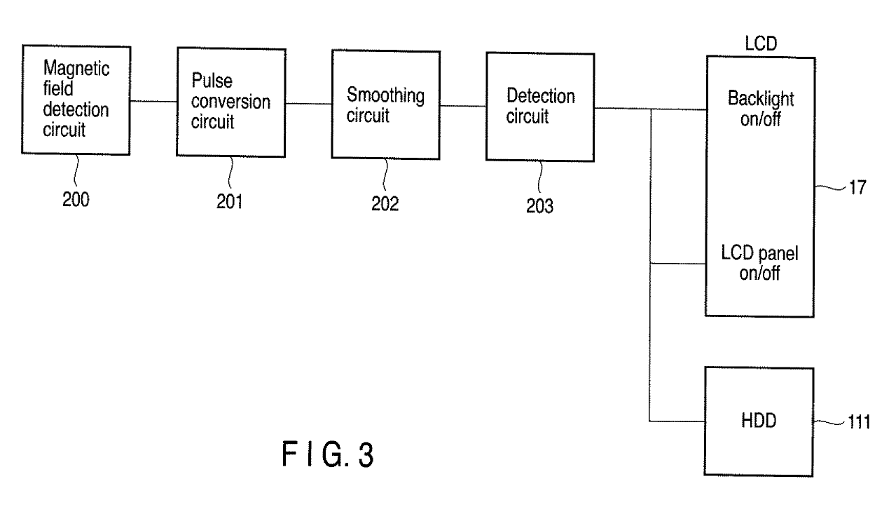

The process of obtaining an angle from a detected magnetic field will be described next with reference to FIG. 3. The computer 10 includes a magnetic field detection circuit 200, pulse conversion circuit 201, smoothing circuit 202, and detection circuit 203. The magnetic field detection circuit 200 detects a magnetic field generated by a magnet or the like. The pulse conversion circuit 201 is a PWM circuit which converts a generated magnetic field into a pulse signal having a pulse width corresponding to the magnetic field. The smoothing circuit 202 converts the output from the pulse conversion circuit 201 from digital to analog using a filter such as RC. The detection circuit 203 is, e.g., the EC/KBC 116 or a microcomputer having a table capable of setting in advance a voltage to turn on/off the LCD backlight and LCD display and performs control based on a result of comparison with a voltage smoothed by the smoothing circuit 202. The LCD 17 is turned on/off by the output from the detection circuit 203. The HDD 111 retracts the read head based on the output from the detection circuit 203 when the open/close speed increases to a predetermined value or more.

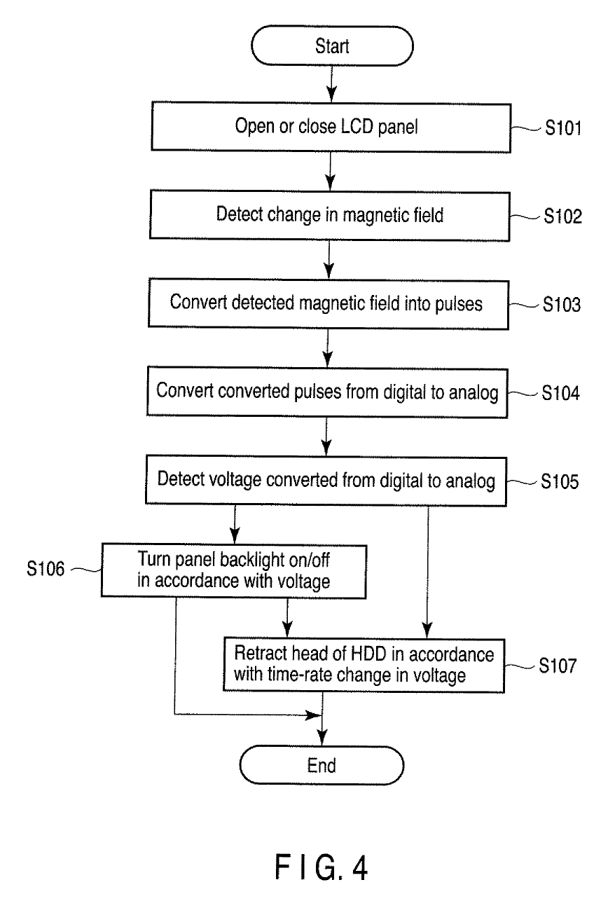

A panel control method using the information processing apparatus according to the embodiment of the present invention will be described next with reference to the flowchart in FIG. 4.

When the user opens or closes the LCD (panel) 17 (display unit 12) (block S101), the magnetic sensor (magnetic field detection circuit 200) 20 detects a change in the magnetic field of the magnet 21 incorporated in the display unit 12 (block S102). The detected magnetic field becomes weaker as the distance between the magnetic sensor 20 and the magnet 21 incorporated in the display unit 12 increases. Conversely, the detected magnetic field becomes stronger as the distance between the magnetic sensor 20 and the magnet 21 incorporated in the display unit 12 shortens. The pulse conversion circuit 201 converts the detected magnetic field into pulses (block S103). The converted pulse signal is converted from digital to analog (block S104). The voltage converted from digital to analog is detected (block S105). The backlight of the display unit 12 is turned on/off based on the obtained open/close angle (voltage) of the display unit 12 with respect to the computer main body 11. For example, control is done using a hysteresis to turn on the backlight at a voltage of 3 V or more and off at a voltage of 0.7 V or less, as shown in FIG. 7.

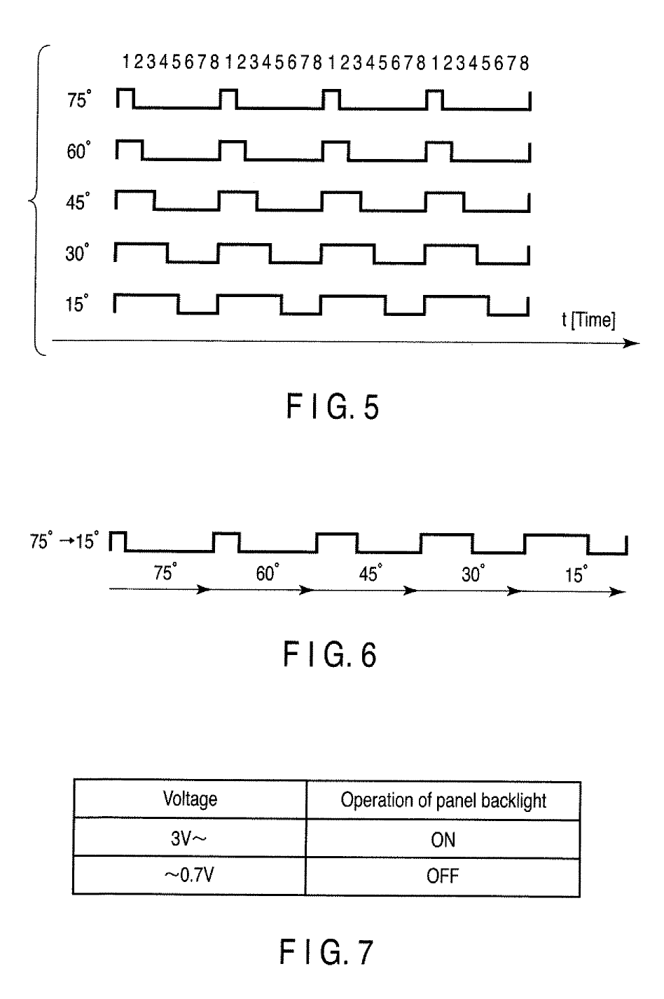

When the converted pulse signal is converted from digital to analog, waveforms as shown in FIG. 5 are obtained. A change in an obtained waveform can be detected in accordance with the open/close angle (e.g., 15° to 75°) It is also possible to detect a change speed, as shown in FIG. 6. If the change speed has reached a predetermined value or more, the head of the HDD can retreat to prepare for impact (block S107).

According to the above-described embodiment, the backlight can be on/off-controlled using hysteresis. The convenience can increase because the backlight is prevented from turning off or shifting to power saving mode when the user has closed the panel just a little. It is also possible to increase the resistance against impact by detecting the open/close speed to detect impact in advance, and retracting the head of the HOD.

It is an object of the present invention to provide an information processing apparatus and a panel control method which can set a process to be executed at each of the open and close angles of a display unit. In the above-described embodiment, the EC/KBC 116 implements the detection circuit 203. However, the present invention is not limited to this. The detection circuit 203 can also be implemented by, e.g., an application that runs on the operating system in cooperation with it.

Note that the present invention is not exactly limited to the above embodiments, and constituent elements can be modified in the execution stage without departing from the spirit and scope of the invention.

Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

While certain embodiments of the Inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a housing;
a display unit pivotally installed on the housing and including a magnet unit;
a magnetic sensor unit incorporated in the housing to detect a movement of the magnet unit;
a conversion unit which converts a magnetic force detected by the magnetic sensor unit into a pulse signal having a pulse width;
a detection unit which detects an angle made by the display unit and the housing based on the pulse signal converted by the conversion unit and having the pulse width;
a storage unit which stores table information storing an operation corresponding to a predetermined angle; and
an operation unit which performs the predetermined operation based on the table information when the detected angle has increased to the predetermined angle, and performs the predetermined operation based on the table information when the detected angle has decreased to the predetermined angle.

2. The apparatus according to claim 1, wherein the predetermined angle when the detected angle increases is larger than the predetermined angle when the detected angle decreases.

3. The apparatus according to claim 1, wherein when the detected angle has increased to the predetermined angle, a backlight of the display unit is turned on, and when the detected angle has decreased to the predetermined angle, the backlight of the display unit is turned off.

4. The apparatus according to claim 1, wherein if the detected angle decreases to not less than a predetermined decrease speed, the storage unit receives an appropriate treatment.

5. A panel control method used by an information processing apparatus including a housing, a display unit pivotally installed on the housing and including a magnet unit, a magnetic sensor unit incorporated in the housing to detect a movement of the magnet unit, and a conversion unit which converts a magnetic force detected by the magnetic sensor unit into a pulse signal having a pulse width, comprising:
detecting an angle made by the display unit and the housing based on the pulse signal converted by the conversion unit and having the pulse width;
storing, in a storage unit, table information storing an operation corresponding to a predetermined angle;
performing the predetermined operation based on the table information when the detected angle has increased to the predetermined angle; and
performing the predetermined operation based on the table Information when the detected angle has decreased to the predetermined angle.

6. The method according to claim 5, wherein the predetermined angle when the detected angle increases is larger than the predetermined angle when the detected angle decreases.

7. The method according to claim 5, wherein when the detected angle has increased to the predetermined angle, a backlight of the display unit is turned on, and when the detected angle has decreased to the predetermined angle, the backlight of the display unit is turned off.

8. The method according to claim 5, wherein if the detected angle decreases to not less than a predetermined decrease speed, the storage unit receives an appropriate treatment.
